(19) United States
(12) Patent Application Publication
(10) Pub. No.: US 2004/0185172 A1
(43) Pub. Date: Sep. 23, 2004

(54) Method of forming film for organic electrified light emitting elements

(76) Inventors: I-Ming Liu, Hsinchu (TW); Ming-Yang Chuang, Nantou (TW); I-Cheng Kuo, Taichung (TW); Wei-Yang Cheng, Hsinchu (TW)

Correspondence Address: BIRCH STEWART KOLASCH & BIRCH, PO BOX 747, FALLS CHURCH, VA, 22040-0747, US

(21) Appl. No.: 10/391,651

(22) Filed: Mar. 20, 2003

(51) Int. Cl. B05D 5/12

(52) U.S. Cl. 427/69; 427/282

(57) ABSTRACT

A method of forming a film for organic electrified light emitting elements includes aligning a substrate with a shadow mask outside a vacuum deposition chamber; moving the aligned substrate and the shadow mask into the vacuum deposition chamber through a robotic arm and holding the aligned substrate and the shadow mask through an alignment mechanism; and plating an organic material from a vaporization material by vaporization to form a film of the organic electrified light emitting elements on the substrate.

### FIELD OF THE INVENTION

The present invention relates to a method of forming a film for organic electrified light emitting elements and particularly to a method that separates alignment apparatus and film forming apparatus to enable a substrate to be sent into a vacuum deposition chamber for directly plating a film on the substrate by vaporization.

### BACKGROUND OF THE INVENTION

To make organic electrified light emitting elements that have high efficiency of light emitting properties, the most cost effective fabrication method nowadays is to form an organic light emitting layer from an organic material by blended vaporization. The processes involve a shadow mask and vacuum molding to form miniaturized patterns for the organic material. The interval between the shadow mask and the substrate must be very small to achieve a high resolution. If the shadow mask is directly in contact with the substrate, the segment film forming process at the later stage could cause damage to the film previously formed. One conventional method to overcome this problem of miniaturized machining for the cathode is to provide a separator. The separator enables the cathode to automatically generate patterns and support the materials during selective forming of the organic film.

Refer to FIGS. 1A, 1B and 1C for a conventional method for forming an organic light emitting film. An anode 12 and a cathode separator 13 are respectively formed on a substrate 11. Then a shadow mask 14 is disposed on a preset location to grow a red light emitting material R. The shadow mask 14 is supported by the cathode separator 13 without directly in contact with the anode 12 of the substrate 11. Next, the shadow mask 14 is lifted and moved to the right for a pitch and is rested on another cathode separator 13 without overlapping or in contact with the red light emitting material R, and a green light emitting G is precisely formed. The similarly process is repeated to form a blue light emitting material B. Finally a tricolor RGB organic light emitting layer is formed.

The cathode separator 13 is a structure with a taper shape located on the substance 11 to support the shadow mask 14 and automatically provide insulation to separate the metal film of the cathode.

Refer to FIGS. 2A through 2D for the process flow of a conventional method for forming an organic electrified light emitting elements. First, a substrate 21 is sent into a vacuum deposition chamber 23 by means of a robotic arm 22, and the substrate 21 is aligned with a shadow mask 25 located in the vacuum deposition chamber 23 through an alignment control mechanism 24. Next, an organic material is plated on the substrate 21 by vaporization from a vaporization source 26. Finally, the substrate 21 with the film of the organic electrified light emitting element formed thereon is removed from the vacuum deposition chamber 23.

Refer to FIG. 3 for a conventional apparatus for mass production of the organic electrified light emitting elements. Adopted the processes set forth above, a robotic arm 31 is employed to control the substrate in various vacuum deposition chambers 32 to process operations of forming a wired film for the organic electrified light emitting film and the metal electrode (cathode). The substrate is conveyed through a transfer chamber 33.

In the conventional process of forming the organic electrified light emitting film mentioned above, the filming forming and alignment mechanism are located in the same vacuum deposition chamber. Hence the substrate must be aligned with the shadow mask before being sent into the vacuum deposition chamber for the vaporization plating process. Moreover, during forming the film, the alignment mechanism cannot be used. This results in a waste, and increases process time and operations.

### SUMMARY OF THE INVENTION

Therefore the primary object of the invention is to resolve the aforesaid disadvantages. The invention allows the substrate to complete alignment with the shadow mask before the substrate is sent into the vacuum deposition chamber so that the substrate may be directly treated with vaporization plating process once inside the vacuum deposition chamber. Thus time required for film forming is shortened and production efficiency may increase.

In order to achieve the foregoing object the process method for forming a film of organic electrified light emitting elements includes: completing alignment of the substrate and the shadow mask outside the vacuum deposition chamber; moving the aligned substrate and shadow mask into the vacuum deposition chamber through a robotic arm; holding the substrate and shadow mask by means of an alignment holding mechanism; and plating an organic material from a vaporizing source on the substrate by vaporization to form a film of organic electrified light emitting elements.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A, 1B and 1C are schematic views of forming an organic light emitting film.

FIGS. 2A, 2B, 2C and 2D are schematic views of a conventional process flow for forming a film of organic electrified light emitting elements.

FIG. 3 is a schematic view of a conventional apparatus for mass production of the organic electrified light emitting elements.

FIG. 4A is a schematic view of a first process step of the invention for forming a film of organic electrified light emitting elements.

FIG. 4B is a schematic view of a second process step of the invention for forming a film of organic electrified light emitting elements.

FIG. 4C is a schematic view of a third process step of the invention for forming a film of organic electrified light emitting elements.

FIG. 5 is a schematic view of an alignment holding mechanism of the invention.

FIG. 6 is a schematic view of the apparatus for mass production of the organic electrified light emitting elements according to the invention.

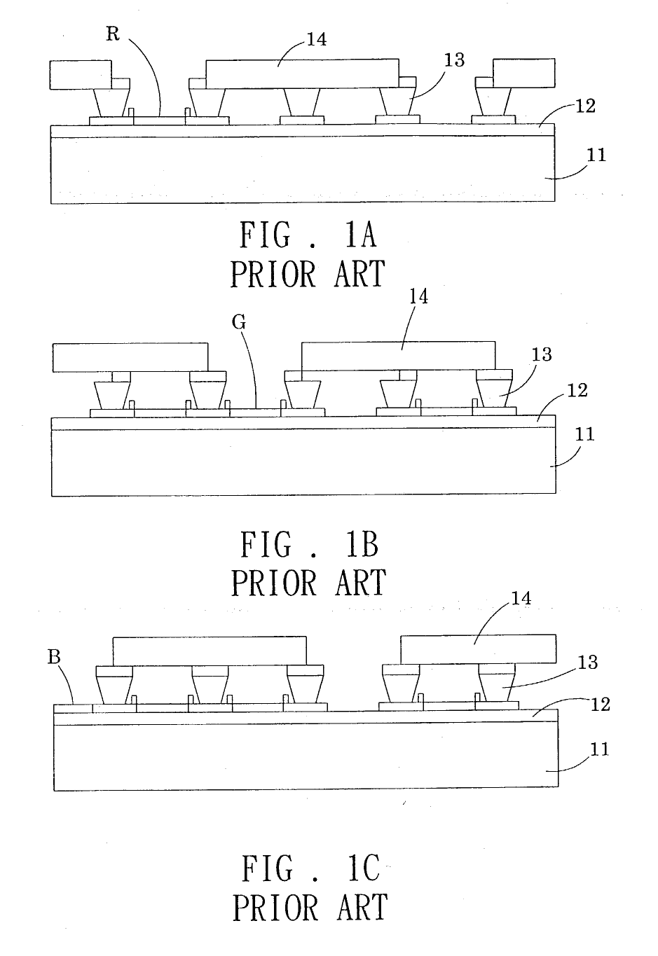

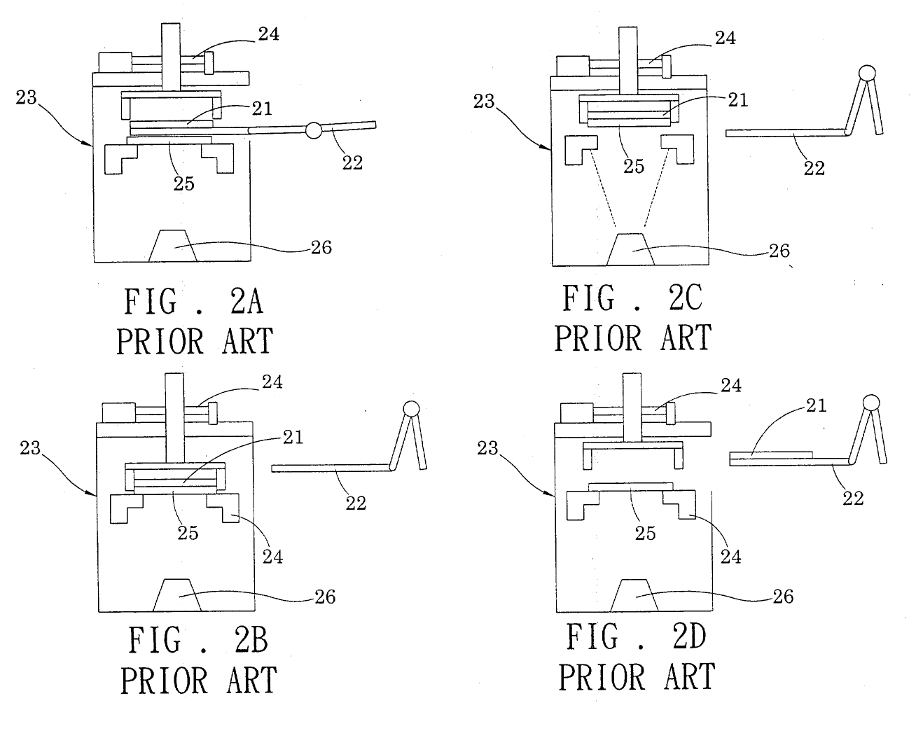

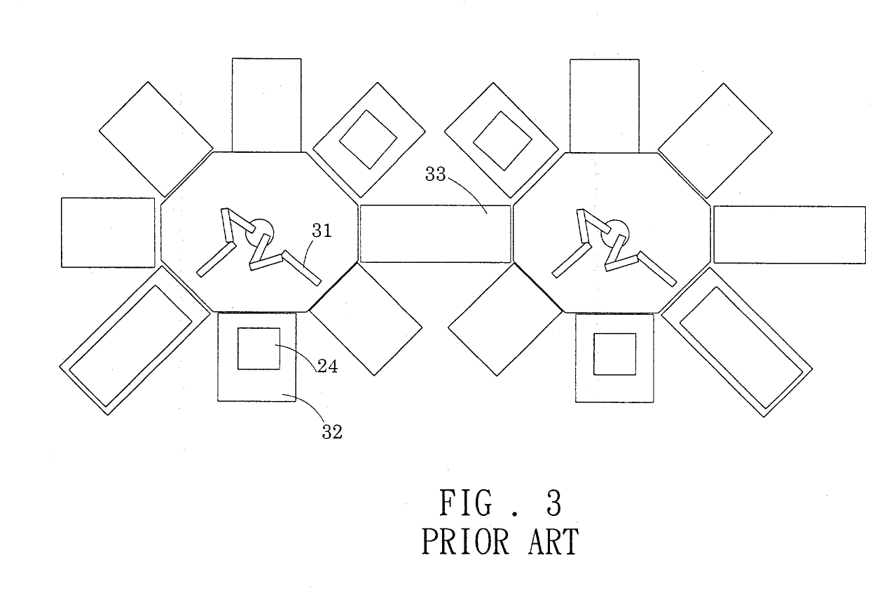

### DETAILED DESCRIPTION OF THE INVENTION

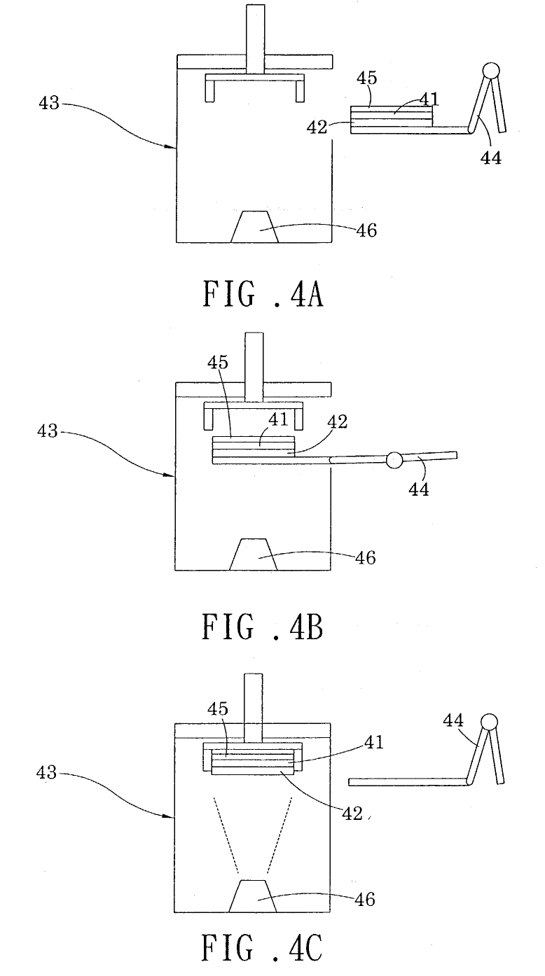

Referring to FIG. 4A, the first process step for forming a film of organic electrified light emitting elements according to the invention is to complete the alignment of a substrate 41 with a shadow mask 42 outside a vacuum deposition chamber 43, and hold the substrate 41 and the shadow mask 42 by means of a robotic arm 44 of an alignment mechanism 45.

FIG. 4B illustrates the second process step for forming a film of organic electrified light emitting elements according to the invention. The aligned substrate 41 and the shadow mask 42 are transferred into the vacuum chamber 43 through the robotic arm 44.

FIG. 4C illustrates the third process step for forming a film of organic electrified light emitting elements according to the invention. A film of an organic material is plated on the substrate 41 from a vaporization material 46 by vaporization to form the organic electrified light emitting elements.

The alignment of the substrate 41 and the shadow mask 42 is accomplished by means of a CCD (charge-coupled device) video camera (not shown in the drawings). Trough an image process program, alignment notations marked on the shadow mask 42 and the substrate 41 are recognized, then the center points of the shadow mask 42 and the substrate 41, and the contained angle between the substrate 41 and the shadow mask 42 are calculated. Thereafter, the displacement vector is calculated for moving the substrate 41 or the shadow mask 42 to make alignment.

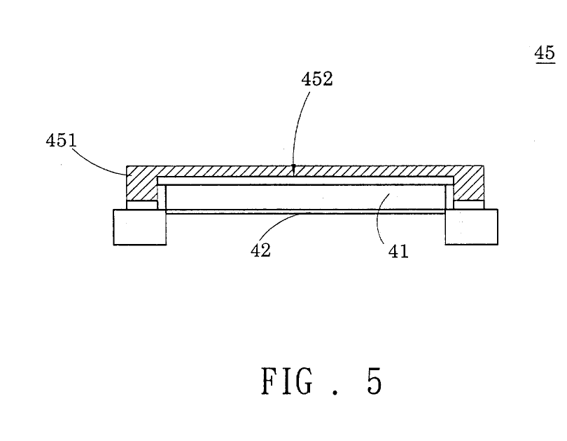

Refer to FIG. 5 for the alignment mechanism 5. The shadow mask 42 is made from metal. The substrate 41 and the shadow mask 42 are grasped and held by a magnetic holding dock 451 so that they are not deviated from the aligned relationship during the moving process of the substrate 41 and the shadow mask 42.

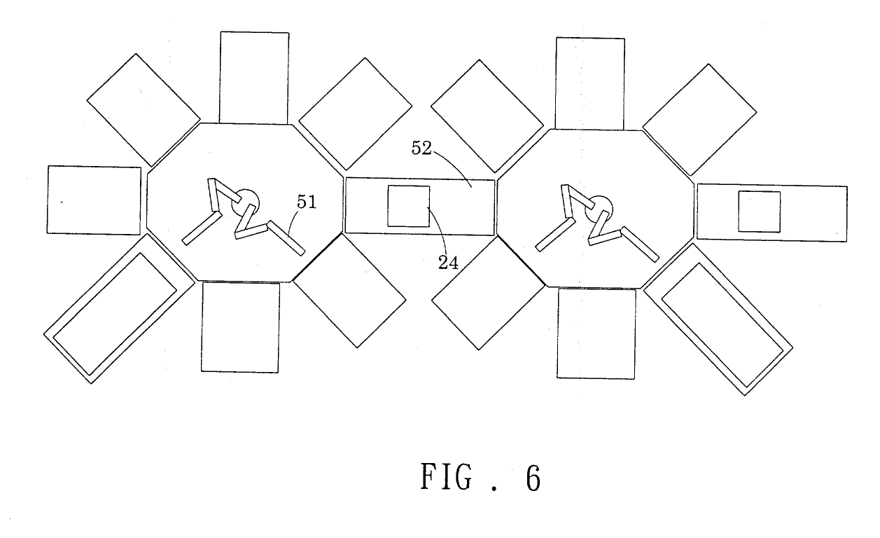

Refer to FIG. 6 for the apparatus for mass production of the organic electrified light emitting elements according to the invention. When a robotic arm 51 transfers the substrate (not shown in the drawing) into a transfer chamber 52, it also simultaneously performs the function of aligning the substrate and the shadow mask 42 rather than simply transfers the substrate as the conventional method does.

In summary, the invention provides the following advantages:

1. Time for forming the film is shortened.

2. The separation design of the alignment mechanism and the film forming mechanism reduces the pollution of the substrate resulting from external objects attached to the alignment mechanism.

3. The separation design of the alignment mechanism and the film forming mechanism simplifies the design of the vacuum deposition chamber and improves vacuumizing efficiency.

4. The separation design of the alignment mechanism and the film forming mechanism enables the substrate and the shadow mask to be aligned in a non-vacuum environment.

5. Total costs of the film forming apparatus decrease.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of forming a film for organic electrified light emitting elements, comprising steps of:
a. aligning a substrate with a shadow mask outside a vacuum deposition chamber;
b. moving the aligned substrate and the shadow mask into the vacuum chamber through a robotic arm; and
c. plating an organic material from a vaporization material by vaporization to form a film of the organic electrified light emitting elements on the substrate.

2. The method of claim 1, wherein the robotic arm has an alignment mechanism which has a magnetic holding dock to hold the substrate and the shadow mask.

3. The method of claim 1, wherein the aligning a substrate with a shadow mask is accomplished by means of a CCD (charge-coupled device) video camera trough an image process program that recognizes alignment notations marked on the shadow mask and the substrate to calculate the center points of the shadow mask and the substrate, and the contained angle between the substrate and the shadow mask, and a displacement vector for moving the substrate or the shadow mask to achieve the alignment.
